(19) United States
(12) Patent Application Publication
(10) Pub. No.: US 2018/0078090 A1
(43) Pub. Date: Mar. 22, 2018

(54) KAMADO STYLE COOKER SYSTEM

(71) Applicant: Goldens' Foundry & Machine Company, Columbus, GA (US)

(72) Inventors: George Golden Boyd, SR., Columbus, GA (US); George Golden Boyd, JR., Columbus, GA (US); Edward Sprouse Boyd, SR., Columbus, GA (US); John Thomas Boyd, II, Columbus, GA (US); John Toland, Columbus, GA (US); David Byrd, Phenix City, AL (US); Wallace Sims, JR., Phenix City, AL (US); Aurelio Hernandez, Phenix City, AL (US)

(73) Assignee: Goldens' Foundry & Machine Company, Columbus, GA (US)

(21) Appl. No.: 15/712,699

(22) Filed: Sep. 22, 2017

Related U.S. Application Data
(60) Provisional application No. 62/398,238, filed on Sep. 22, 2016.

(51) Int. Cl. A47J 37/07; A47J 36/12; A47J 36/34; B62B 3/10; B62B 5/06

(52) U.S. Cl. CPC A47J 37/0763; A47J 37/0786; B62B 5/061; A47J 36/34; B62B 3/10; A47J 36/12

(57) ABSTRACT

A kamado style cooker system includes a kamado style cooker and a cooker cart. The kamado style cooker includes a pot and a cover hingedly connected to the pot. The cooker cart includes a base having a first side, a second side opposite the first side, and at least one horizontal base support on which the cooker sits.

### REFERENCE TO RELATED APPLICATIONS

This application claims the benefit of U.S. Provisional Application No. 62/398,238, filed Sep. 22, 2016 and entitled KAMADO STYLE COOKER SYSTEM, the contents of which are hereby incorporated by reference in its entirety.

### FIELD OF THE INVENTION

Embodiments of invention relate to cooker systems, and more particularly to cast iron kamado style cooker systems.

### BACKGROUND

A kamado cooker is a traditional Japanese wood or charcoal fueled cook stove. Modern versions of the cooker are believed to derive from clay vessels used by humans to cook food for many thousands of years. A common fault in the original Japanese design is that clay and ceramic materials tend to crack over time. Modern ceramic and refractory materials decrease cracking only to some extent, and Portland cement is still associated with cracking problems. Accordingly, a shortcoming of modern Kamado-style cookers is their lack of strength and durability because of the use of ceramic and refractory lining materials.

### SUMMARY

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various embodiments of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

According to certain examples, a kamado style cooker system includes a kamado style cooker and a cooker cart. In some examples, the kamado style cooker includes a pot and a cover hingedly connected to the pot. In certain examples, the cooker cart includes a base having a first side, a second side opposite the first side, and a plurality of base supports. In some examples, the first side includes first side supports and the second side includes second side supports. In various cases, the cooker cart defines a front gap at a front side of the cooker cart between the first side supports and the second side supports at the front side of the cooker cart. In some examples, the kamado style cooker is secured to at least one of the plurality of base supports between the first side supports and the second side supports.

In some examples, the pot is monolithically formed and includes a pot body, a pot hinge plate, and a pot circumferential band. In certain cases, the cover is monolithically formed and includes a cover body, a cover circumferential band, and a cover hinge plate. In various embodiments, the pot hinge plate extends from the pot circumferential band and includes two upwardly extending flanges. In certain cases, the cover hinge plate extends from the cover circumferential band and includes two downwardly extending flanges. In certain cases, the downwardly extending flanges at least partially overlap the upwardly extending flanges.

In various examples, the kamado style cooker further includes a hinge mechanism having at least one torsion spring installed on a hinge pin. In some examples, the first side of the cooker cart includes a first side handle connected to the first side supports, and the second side of the cooker cart includes a second side handle connected to the second side supports.

According to some examples, the cooker cart further defines a back gap at a back side of the cooker cart opposite from the front gap between the first side supports and the second side supports at the back side of the cooker cart. In certain examples, the front gap is configured to receive a handle of the pot of the kamado style cooker and a handle of the cover of the kamado style cooker. In various cases, the back gap is configured to receive a hinge mechanism of the kamado style cooker. In certain cases, the hinge mechanism includes a pot hinge plate extending from a pot circumferential band of the pot and a cover hinge plate extending from a cover circumferential band of the cover.

In some embodiments, the cooker cart further includes a first side shelf at the first side and a second side shelf at the second side. In various examples, the first side shelf is attached to the first side supports and the second side shelf is attached to the second side supports. In various examples, the cooker cart further includes a first side handle attached to the first side supports and a second side handle attached to the second side supports, and the first side shelf is supported by the first side handle and the second side shelf is supported by the second side handle.

In certain examples, the kamado style cooker is a first kamado style cooker and the kamado style cooker system further includes a second kamado style cooker. In some cases, the second kamado style cooker includes a pot and a cover hingedly connected to the pot, and the second kamado style cooker is secured to at least one of the plurality of base supports between the first kamado style cooker and the second side.

In some cases, the cooker cart further includes at least one shelf support. In various examples, the cooker cart further includes a first set of wheels at the first side of the cooker cart. In some examples, the cooker cart further includes a second set of wheels at the second side of the cooker cart. In some cases, a diameter of each of the first wheels is less than a diameter of each of the second wheels. In certain aspects, a diameter of each of the first wheels is the same as a diameter of each of the second wheels. In various aspects, the cooker cart further comprises a set of stands at the second side of the cooker cart. In various cases, the cooker comprises cast iron.

According to certain embodiments, a kamado style cooker system includes a kamado style cooker with a pot and a cover hingedly connected to the pot. The kamado style cooker system also includes a cooker cart. In some examples, the cooker cart includes a base having a first side, a second side opposite the first side, and at least one horizontal base support upon which the kamado style cooker rests. In various examples, the first side includes first side supports extending upwardly form the at least one horizontal base support and the second side comprises second side supports extending upwardly from the at least one horizontal base support. In certain aspects, the cooker cart defines a front gap at a front side of the cooker cart between one of the first side supports and one of the second side supports at the front side of the cooker cart. According to certain embodiments, the kamado style cooker is secured to the at least one horizontal base support between the first side supports and the second side supports.

In various examples, the pot is monolithically formed and includes a pot body, a pot hinge plate, and a pot circumferential band, and the cover is monolithically formed and includes a cover body, a cover circumferential band, and a cover hinge plate. In some cases, the pot hinge plate extends from the pot circumferential band and includes two upwardly extending flanges, and the cover hinge plate extends from the cover circumferential band and includes two downwardly extending flanges. In certain examples, the downwardly extending flanges at least partially overlap the upwardly extending flanges.

In some examples, the kamado style cooker further includes a hinge mechanism having at least one torsion spring installed on a hinge pin. In certain cases, the first side of the cooker cart includes a first side handle extending from the first side supports, and the second side of the cooker cart includes a second side handle extending from the second side supports. In some embodiments, the cooker cart further defines a back gap at a back side of the cooker cart opposite from the front gap between the first side supports and the second side supports. According to various embodiments, the front gap is configured to accommodate a handle of the pot of the kamado style cooker and a handle of the cover of the kamado style cooker, and the back gap is configured to accommodate a hinge mechanism of the kamado style cooker

According to certain aspects, the cooker cart further includes a first side shelf at the first side and a second side shelf at the second side. In some examples, the first side shelf is attached to the first side supports and wherein the second side shelf is attached to the second side supports. In various examples, the first side shelf is attached to a first handle and the second side shelf is attached to a second handle. In some cases, the cooker cart further includes a first side handle attached to the first side supports and a second side handle attached to the second side supports, the first side shelf is supported by the first side handle, and the second side shelf is supported by the second side handle.

In various embodiments, the kamado style cooker is a first kamado style cooker, wherein the kamado style cooker system further includes a second kamado style cooker having a pot and a cover hingedly connected to the pot, and the second kamado style cooker is secured to the at least one horizontal base support between the first kamado style cooker and the second side.

In certain aspects, the kamado style cooker system further includes a divider dividing the pot into a first zone and a second. In various examples, the divider includes a body having a peripheral edge, wherein the peripheral edge comprises a profile matching a shape of an inner surface of the pot and a pair of feet at a bottom of the body. In various embodiments, the divider is removable from the kamado style cooker.

According to certain examples, a cooker cart for a kamado style cooker includes a base having a first side, a second side opposite the first side, and at least one horizontal base support configured to support a kamado style cooker rests. In some cases, the first side includes first side supports extending upwardly form the at least one horizontal base support and the second side includes second side supports extending upwardly from the at least one horizontal base support. In various embodiments, the cooker cart defines a front gap at a front side of the cooker cart between one of the first side supports and one of the second side supports at the front side of the cooker cart. In some cases, at least one horizontal base support is configured to secure the kamado style cooker between the first side supports and the second side supports

In some examples, the first side of the cooker cart includes a first side handle extending from the first side supports, and the second side of the cooker cart includes a second side handle extending from the second side supports. In various cases, the cooker cart further defines a back gap at a back side of the cooker cart opposite from the front gap between the first side supports and the second side supports. In certain aspects, the cooker cart further includes a first side shelf at the first side and a second side shelf at the second side. According to some examples, the first side shelf is attached to a first side handle and wherein the second side shelf is attached to a second side handle.

Various implementations described in the present disclosure can include additional systems, methods, features, and advantages, which cannot necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The features and components of the following figures are illustrated to emphasize the general principles of the present disclosure. Corresponding features and components throughout the figures can be designated by matching reference characters for the sake of consistency and clarity.

FIG. 1 is top rear perspective view of a cooker system according to aspects of the current disclosure.

FIG. 2 is an top front perspective view of the cooker system of FIG. 1.

FIG. 3 is another top front perspective view of the cooker system of FIG. 1.

FIG. 4 is another top rear perspective view of the cooker system of FIG. 1.

FIG. 5 is another top front perspective view of the cooker system of FIG. 1.

FIG. 6 is a top front perspective view of a cooker system according to aspects of the current disclosure.

FIG. 7 is a top front perspective view of a cooker system according to aspects of the current disclosure.

FIG. 8 is another top front perspective view of the cooker system of FIG. 7.

FIG. 9 is a top side perspective view of the cooker system of FIG. 7.

FIG. 10 is another top front perspective view of the cooker system of FIG. 7.

FIG. 11 is a perspective view of an interior of a cooker with one embodiment of a divider.

FIG. 12 is a top perspective view of another embodiment of a divider

FIG. 13 is a side view of the divider of FIG. 12.

FIG. 14 is an end view of the divider of FIG. 12.

FIG. 15 is a bottom view of the divider of FIG. 12.

### DETAILED DESCRIPTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described. Directional references such as “up,” “down,” “top,” “left,” “right,” “front,” and “back,” among others are intended to refer to the orientation as illustrated and described in the figure (or figures) to which the components and directions are referencing.

The subject matter of examples of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

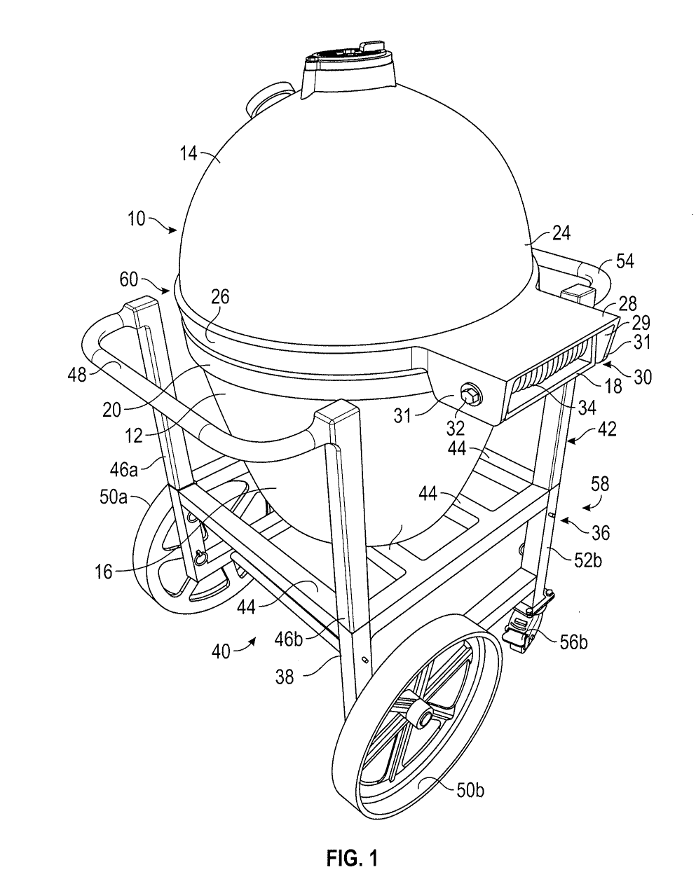

Cast iron kamado style cookers are based on a traditional Japanese wood or charcoal fueled cook stove. Referring to FIG. 1, for example, unlike traditional Japanese cook stoves or modern kamado style cookers, a cast iron kamado style cooker 10 includes an integrally or monolithically formed pot 12. The pot 12 is hingedly connected to an integrally or monolithically formed cover 14. There is a draft opening in the lower side of the pot 12 to provide air to the charcoal, as well as a controllable vent in the top of the cover for air to exit the cooker 10. The temperature within the cooker 10 is controlled by adjusting these two vents. One or more grates may be suspended over the fire to provide the cooking surface(s) for the food.

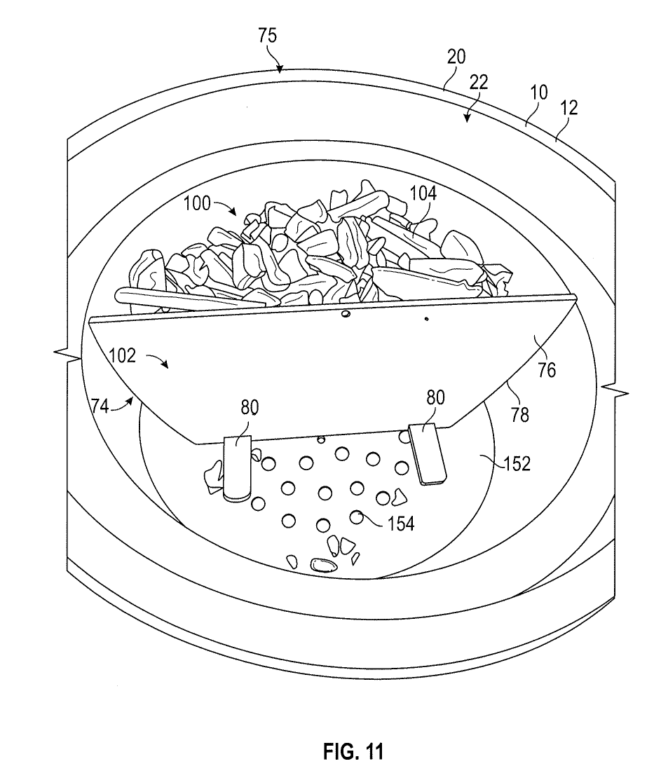

The pot 12 is integrally or monolithically formed in that a pot body 16, a hinge plate 18, and a circumferential band 20 surrounding an opening 22 of the pot (see FIG. 11) are all integral and cast as a unitary piece. The hinge plate 18 extends from the circumferential band 20 and includes upwardly extending flanges 29.

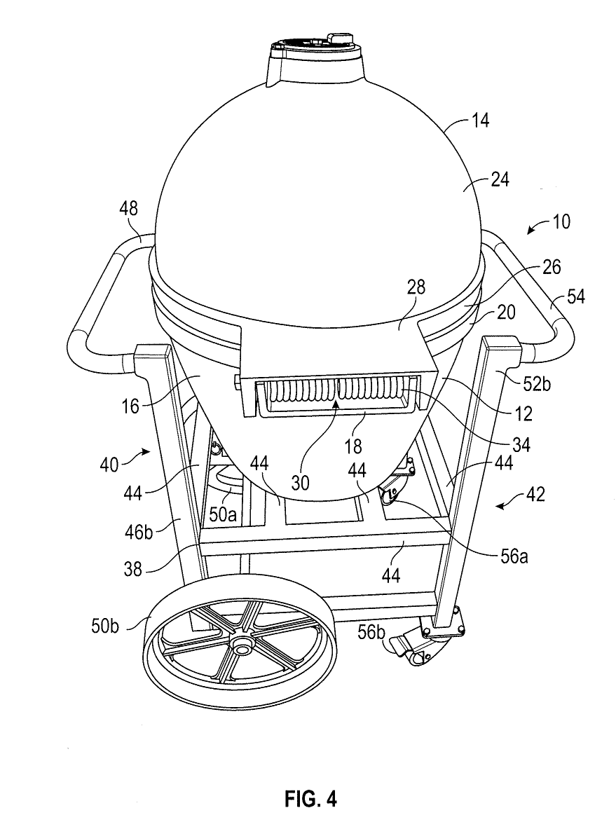

In a similar manner, the cover 14 is integrally or monolithically formed in that a cover body 24, a circumferential band 26 surrounding an opening of the cover body 24, and a hinge plate 28 are all integral and cast as a unitary piece. The hinge plate 28 extends from circumferential band 26 and includes downwardly extending flanges 31 that at least partially overlap with downwardly extending flanges 29 when the cover 14 is positioned on pot 12 (see FIG. 4).

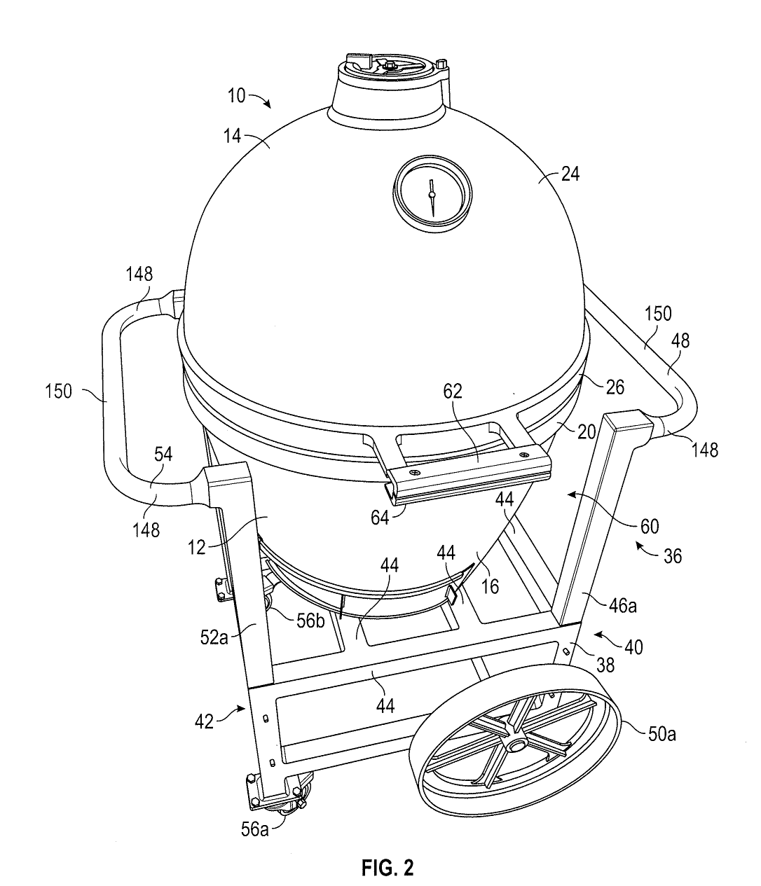

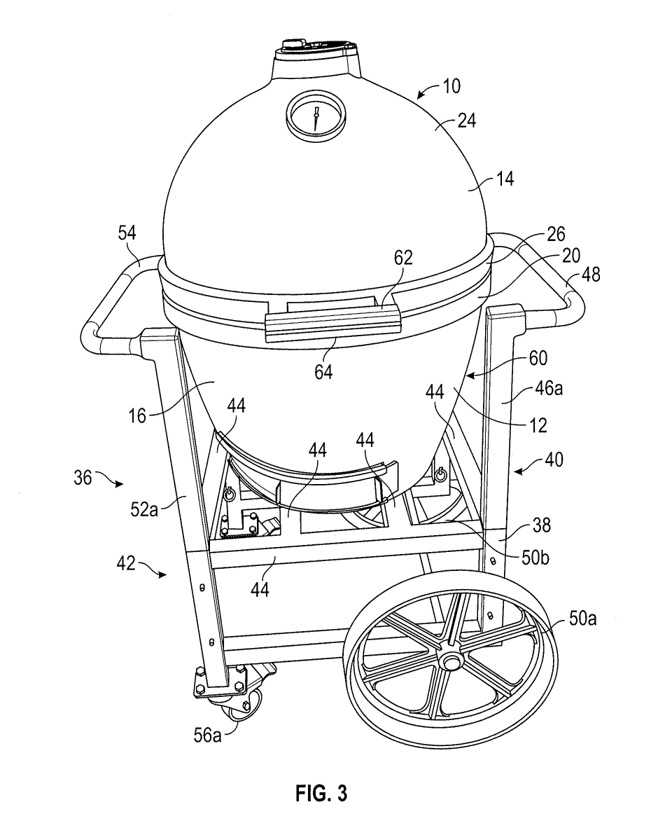

In some examples, cover 14 is hingedly connected to the pot 12 through a hinge mechanism 30. In the present example illustrated in FIGS. 1-4, the hinge mechanism 30 includes one or more torsion springs 34 installed on a hinge pin 32 that extends between the overlapping hinge plates 18 and 28. The spring(s) 34 biases the hinge plates 18 and 28 toward an open configuration during lifting. An example of a cast iron kamado style cooker with this and other hinge mechanisms is disclosed in U.S. application Ser. No. 14/985,852, filed Dec. 31, 2015 (the '852 application), the content of which is hereby incorporated by reference in its entirety.

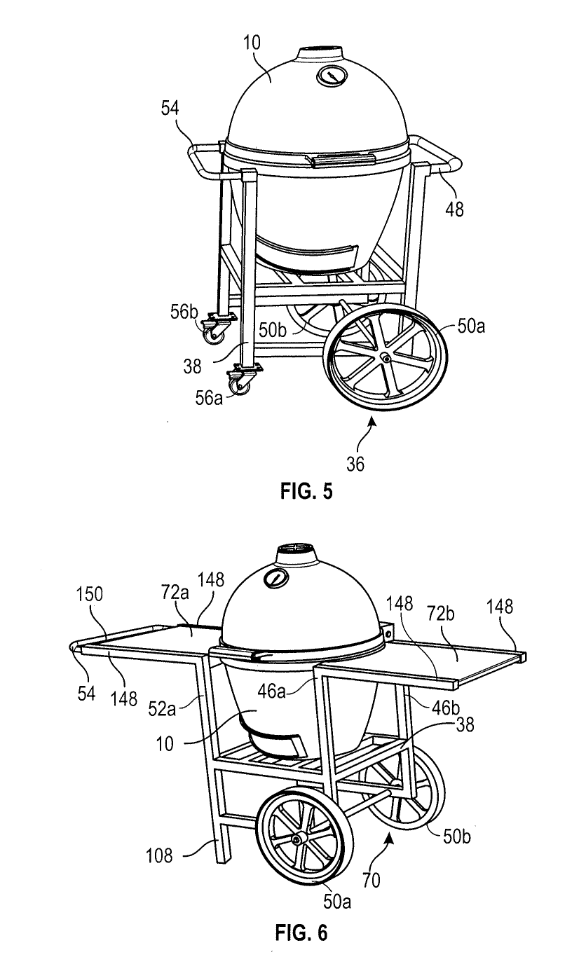

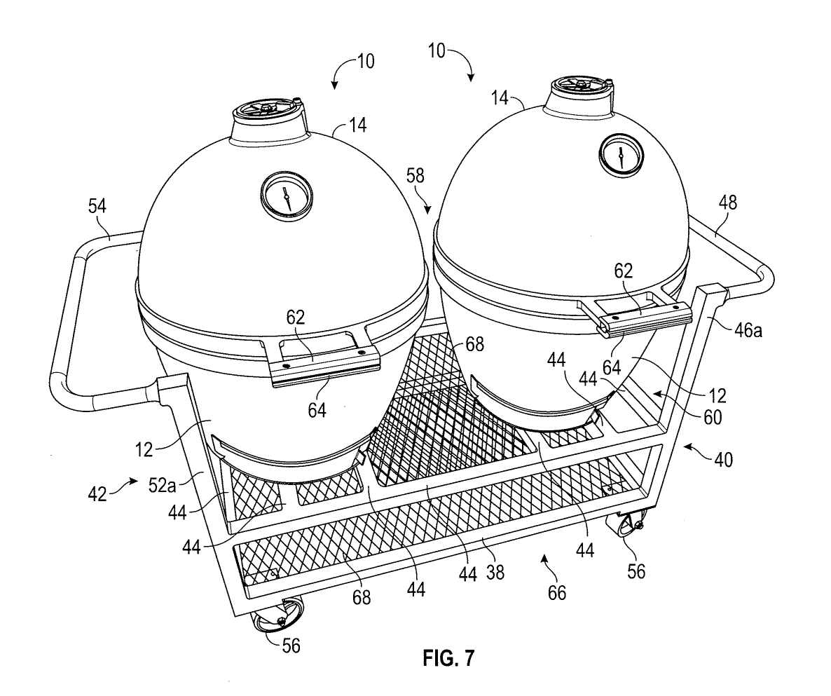

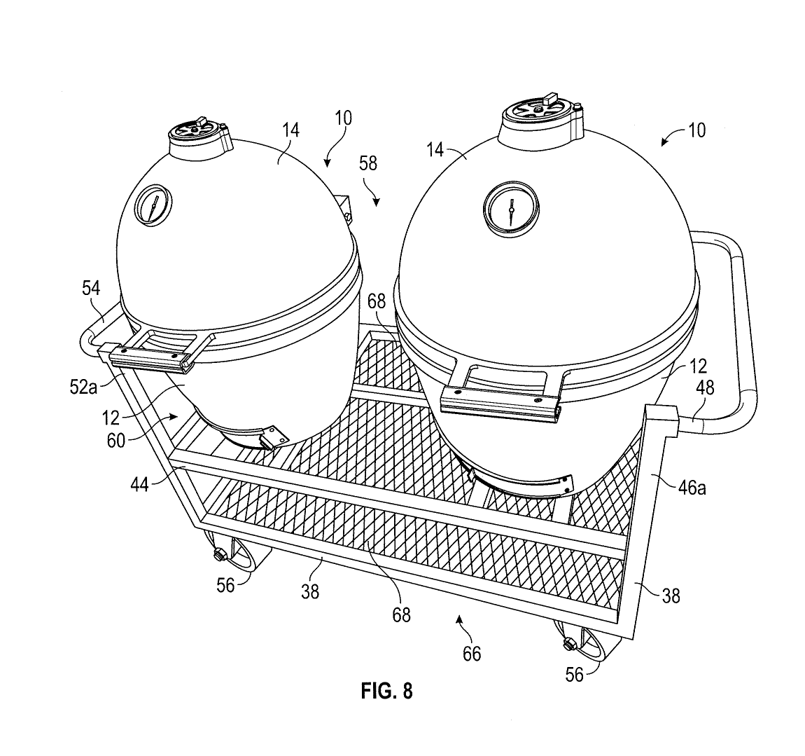

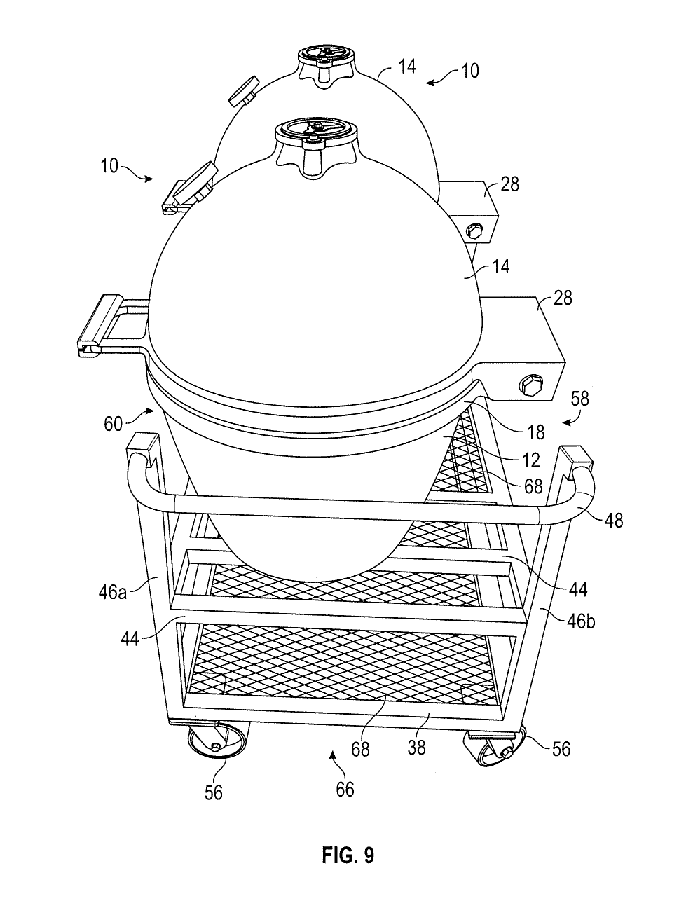

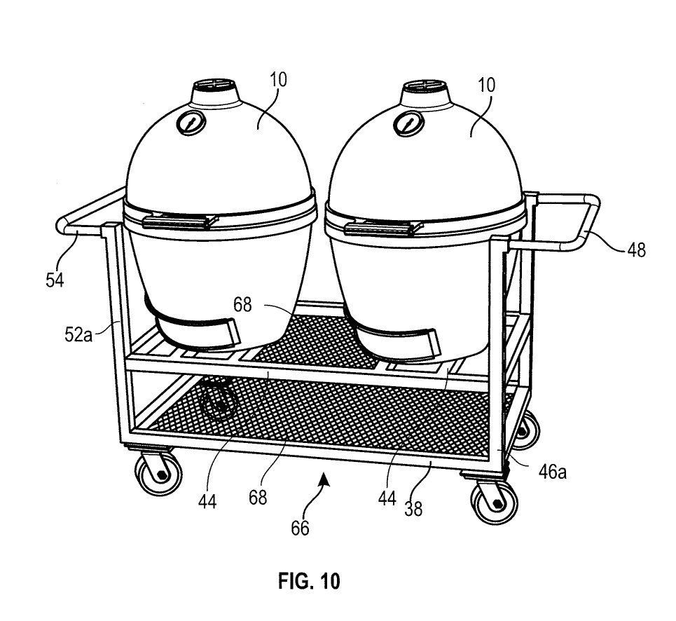

In some examples, because cast iron is relatively heavy and thus difficult for a user to move, cooker carts may be provided to permit movement of the cookers more easily. Such carts may accommodate one cast iron kamado style cooker 10 (FIGS. 1-6) or multiple cookers 10 (FIGS. 7-10).

Referring to FIGS. 1-5, one embodiment of a cooker cart 36 for the cast iron kamado style cooker 10 is illustrated. In various examples, the cooker cart 36 is constructed from a material of sufficient structural integrity to support at least one cooker 10 including, but not limited to various metals (cast iron, steel, etc.), composites, woods, etc.

The shelfless cooker cart 36 includes a base 38 having a first side 40 and a second side 42. In the illustrated embodiment, the base 38 includes a number of horizontal base supports 44 that are arranged substantially horizontal and configured to support the cast iron kamado style cooker 10. In an alternative embodiment, the horizontal base support 44 may consist of a planar body onto which the cooker 10 is positioned. By way only of example, the horizontal base support 44 may be a sheet of material (solid or apertured) of sufficient structural integrity to support the weight of one or more cookers 10. In various cases, the cast iron kamado style cooker 10 may be secured to at least one of the base supports 44 through various suitable securing mechanisms, including, but not limited to, screws, bolts, pins, hooks, welding, adhesives, and various other suitable securing mechanisms.

The first side 40 includes first side supports 46a-b, a first side handle 48, and first wheels 50a-b. The second side 42 includes second side supports 52a-b, a second side handle 54, and second wheels 56a-b. The first side supports 46a-b and second side supports 52a-b extend upwardly relative to horizontal base supports 44. They can extend substantially perpendicular relative to horizontal base supports 44 or at an angle less than 90°. First and second side handles 48, 54 extend outwardly from first side supports 46a-b and second side supports 52a-b, respectively. First and second side handles 48, 54 may be of any shape (rectilinear, semi-circular, etc.), but in the illustrated embodiment are rectilinear in shape. More specifically, first and second side handles 48, 54 each include a handle extension 148 that extends from each of the first side supports 46a-b and second side supports 52a-b and a hand grip 150 the extends between the handle extensions 148 of each of the first side handle 48 and second side handle 54. The handle extensions 148 may be of any length on, and need not be the same between, each of the first side handle 48 and the second side handle 54. Moreover, the extent to which the first side handle 48 and the second side handle 54 extend from the cart 36 may be adjustable.

The first wheels 50a-b may have a first diameter and the second wheels 56a-b may have a second diameter. In various embodiments, the first diameter is greater than the second diameter. In such embodiments, the cart 36 may more easily pivot and tilt about an axis of the first wheels 50a-b during movement of the cart 36. For example, the user can lift up on second side handle 54 to rotate the cart 36 upwardly and move the cart 36 accordingly. In other examples, the first wheels 50a-b and second wheels 56a-b may have the same diameter.

As illustrated in FIGS. 1-4, the cooker cart 36 defines a back gap 58 between the side supports 46b and 52b and a front gap 60 between the side supports 46a and 52a. The back gap 58 is provided and dimensioned to accommodate the hinge plates 18 and 28. In various examples, the back gap 58 enables the cover 14 to pivot relative to the pot 12 through the hinge mechanism 30. The front gap 60 is provided and dimensioned to accommodate handles 62 and 64 of the pot 12 and cover 14, respectively.

Optional side shelves 72a-b (see FIG. 6) that may serve as food preparation surfaces could be installed on the cart 36 on one or both sides of the cooker 10. However, it may be desirable not to equip the cart 36 with shelves in situations (such as restaurant kitchens) where reduction in the cart footprint is desirable and food preparation surfaces are already aplenty.

FIG. 6 illustrates a winged cooker cart 70 with optional shelves 72a-b. The winged cooker cart 70 is substantially similar to the single cooker cart 36 except that the second wheels 56 are omitted and the winged cooker cart 70 instead includes a pair of cart stands 108. In addition, in the winged cooker cart 70, side shelves 72a-b extend from each side of the winged cooker cart 70. Such side shelves 72a-b could be attached to side supports 46a-b and 52a-b and/or supported by handles 48 and 54 (or more specifically by handle extensions 148 as illustrated in FIG. 6). Note that in the embodiment of FIG. 6 a hand grip 150 is only provided on one side of the cart 70 given that the cart 70 only includes one set of wheels and thus may be manipulated from only one side. Note that the cart 70 could include four wheels and/or two hand grips (as in the cart embodiment of FIGS. 1-5). Moreover, in other embodiments, the cart may not include any wheels and/or hand grips 150.

In other examples, as illustrated in FIGS. 7-10, a double cooker cart 66 may be provided to accommodate two (or more) cast iron kamado style cookers 10. The double cooker cart 66 is substantially similar to the single cooker cart 36 except that the base 38 is elongated in a lateral direction such that two cast iron kamado style cookers 10 are supported on horizontal base supports 44, and the back gap 58 and the front gap 60 are elongated to accommodate two sets of hinge plates 18 and 28 and two sets of handles 62 and 64 of the two cookers 10. Additionally, unlike the single cooker cart 36, the wheels of the double cooker cart 66 are all the same type of wheel (although they need not be). In the present example, all the wheels are the second wheels 56. The double cooker cart 66 may further include one or more shelves 68 for accommodating and storing various items or materials that may be used with the cookers 10. Furthermore, optional side shelves (not shown) may also be provided on the cart 66, such as by mounting them on either or both of side handles 48, 54 (as shown in FIG. 6).

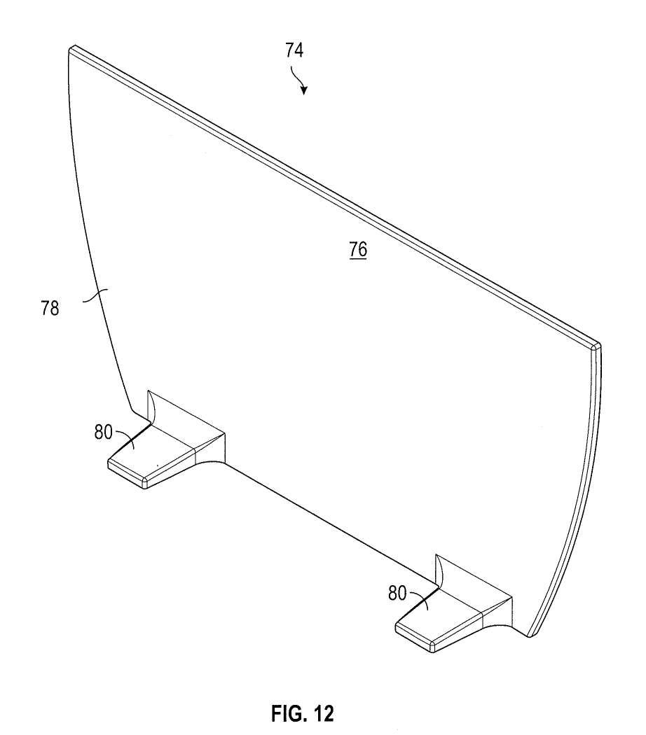

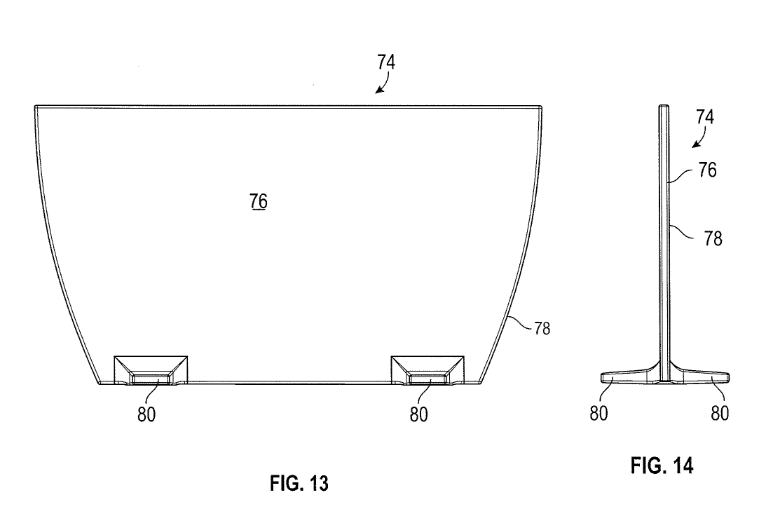

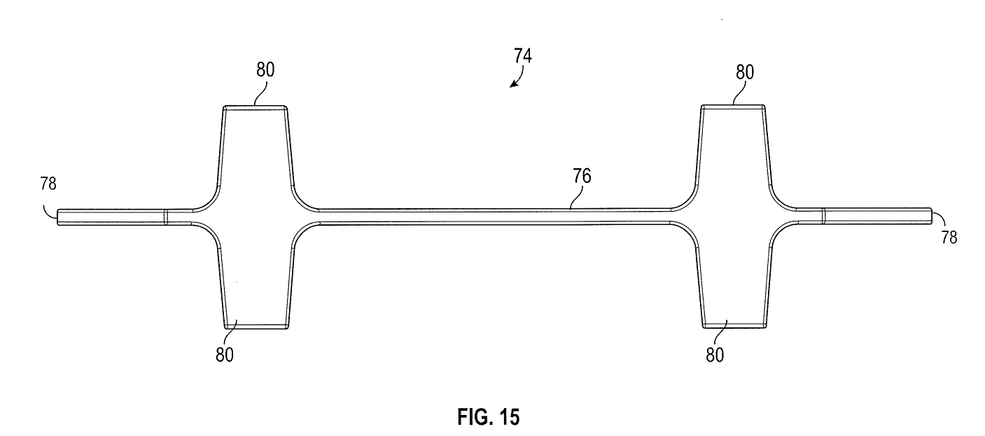

Referring to FIGS. 11-15, in some examples, a divider 74 is provided with the cast iron kamado style cooker 10. One embodiment of the divider 74 is illustrated in FIG. 11 and another embodiment of the divider 74 is illustrated in FIGS. 12-15. The divider 74 is provided to separate a cooking chamber 75 of the pot 12 into at least two distinct zones. For example and without limitation, in some cases, a user may use the divider 74 with the cooker 10 to divide the cooking chamber 75 into a first zone 100 where charcoal or other heat sources 104 may be provided and a second zone 102 where no charcoal or heat source is provided (see FIG. 11). In such cases, a heating profile within the cooker 10 may be adjusted or changed such that some regions within the cooker 10 are hotter than other regions.

The divider 74 includes a body 76 having a peripheral edge 78. At least a portion of the peripheral edge 78 has a profile similar to a shape of the inner surface of the cooking chamber 75. By having similar profiles, the divider 74 can be positioned proximate to the inner surface of the cooking chamber 75 to better isolate the first zone 100 from the second zone 102. Feet 80 are provided at the bottom of the divider 74 such that the divider 74 remains upright relative to a bottom 152 of the cooking chamber 75. As illustrated in FIG. 11, in some examples, the bottom 152 of the cooking chamber 75 may include vent openings 154 such that air may flow through the cooking chamber 75. In some cases, the divider 74 is a solid, unitary component but need not be. In other cases, the divider 74 may include slots or various other openings defined in the body 76.

Different arrangements of the components depicted in the drawings or described above, as well as components and steps not shown or described are possible. Similarly, some features and sub-combinations are useful and may be employed without reference to other features and sub-combinations. Examples of the invention have been described for illustrative and not restrictive purposes, and alternative examples will become apparent to readers of this patent. Accordingly, the present invention is not limited to the examples described above or depicted in the drawings, and various examples and modifications may be made without departing from the scope of the claims below.

That which is claimed:

1. A kamado style cooker system comprising:
a kamado style cooker comprising a pot and a cover hingedly connected to the pot; and
a cooker cart comprising:
a base comprising a first side, a second side opposite the first side, and at least one horizontal base support upon which the kamado style cooker rests,
wherein the first side comprises first side supports extending upwardly form the at least one horizontal base support,
wherein the second side comprises second side supports extending upwardly from the at least one horizontal base support,
wherein the cooker cart defines a front gap at a front side of the cooker cart between one of the first side supports and one of the second side supports at the front side of the cooker cart, and
wherein the kamado style cooker is secured to the at least one horizontal base support between the first side supports and the second side supports.

2. The kamado style cooker system of claim 1, wherein the pot is monolithically formed and comprises a pot body, a pot hinge plate, and a pot circumferential band, and wherein the cover is monolithically formed and comprises a cover body, a cover circumferential band, and a cover hinge plate.

3. The kamado style cooker system of claim 2, wherein the pot hinge plate extends from the pot circumferential band and comprises two upwardly extending flanges, and wherein the cover hinge plate extends from the cover circumferential band and comprises two downwardly extending flanges.

4. The kamado style cooker system of claim 3, wherein the downwardly extending flanges at least partially overlap the upwardly extending flanges.

5. The kamado style cooker system of claim 1, wherein the kamado style cooker further comprises a hinge mechanism comprising at least one torsion spring installed on a hinge pin.

6. The kamado style cooker system of claim 1, wherein the first side of the cooker cart comprises a first side handle extending from the first side supports, and wherein the second side of the cooker cart comprises a second side handle extending from the second side supports.

7. The kamado style cooker system of claim 1, wherein the cooker cart further defines a back gap at a back side of the cooker cart opposite from the front gap between the first side supports and the second side supports.

8. The kamado style cooker system of claim 7, wherein the front gap is configured to accommodate a handle of the pot of the kamado style cooker and a handle of the cover of the kamado style cooker.

9. The kamado style cooker system of claim 7, wherein the back gap is configured to accommodate a hinge mechanism of the kamado style cooker, wherein the hinge mechanism comprises a pot hinge plate extending from a pot circumferential band of the pot and a cover hinge plate extending from a cover circumferential band of the cover.

10. The kamado style cooker system of claim 1, wherein the cooker cart further comprises a first side shelf at the first side and a second side shelf at the second side.

11. The kamado style cooker system of claim 10, wherein the first side shelf is attached to the first side supports and wherein the second side shelf is attached to the second side supports.

12. The kamado style cooker system of claim 10, wherein the cooker cart further comprises a first side handle attached to the first side supports and a second side handle attached to the second side supports, wherein the first side shelf is supported by the first side handle, and wherein the second side shelf is supported by the second side handle.

13. The kamado style cooker system of claim 1, wherein the kamado style cooker is a first kamado style cooker, wherein the kamado style cooker system further comprises a second kamado style cooker comprising a pot and a cover hingedly connected to the pot, and wherein the second kamado style cooker is secured to the at least one horizontal base support between the first kamado style cooker and the second side.

14. The kamado style cooker system of claim 1, further comprising a divider dividing the pot into a first zone and a second, wherein the divider comprises:
a body having a peripheral edge, wherein the peripheral edge comprises a profile matching a shape of an inner surface of the pot; and
a pair of feet at a bottom of the body.

15. The kamado style cooker system of claim 14, wherein the divider is removable from the kamado style cooker.

16. A cooker cart for a kamado style cooker comprising:
a base comprising a first side, a second side opposite the first side, and at least one horizontal base support configured to support a kamado style cooker rests,
wherein the first side comprises first side supports extending upwardly form the at least one horizontal base support,
wherein the second side comprises second side supports extending upwardly from the at least one horizontal base support,
wherein the cooker cart defines a front gap at a front side of the cooker cart between one of the first side supports and one of the second side supports at the front side of the cooker cart, and
wherein at least one horizontal base support is configured to secure the kamado style cooker between the first side supports and the second side supports.

17. The cooker cart of claim 16, wherein the first side of the cooker cart comprises a first side handle extending from the first side supports, and wherein the second side of the cooker cart comprises a second side handle extending from the second side supports.

18. The cooker cart of claim 16, wherein the cooker cart further defines a back gap at a back side of the cooker cart opposite from the front gap between the first side supports and the second side supports.

19. The cooker cart of claim 16, wherein the cooker cart further comprises a first side shelf at the first side and a second side shelf at the second side.

20. The cooker cart of claim 19, wherein the first side shelf is attached to a first side handle and wherein the second side shelf is attached to a second side handle.
